(19) United States
(12) Patent Application Publication
(10) Pub. No.: US 2015/0165723 A1
(43) Pub. Date: Jun. 18, 2015

(54) MOLDED POLYMERIC STRUCTURE, METHOD AND APPARATUS FOR MAKING SAME

(71) Applicant: Lyle SHUERT, Birmingham, MI (US)

(72) Inventor: Lyle SHUERT, Birmingham, MI (US)

(73) Assignee: SHUERT TECHNOLOGY, LLC, Sterling Heights, MI (US)

(21) Appl. No.: 14/571,626

(22) Filed: Dec. 16, 2014

Related U.S. Application Data
(60) Provisional application No. 61/916,474, filed on Dec. 16, 2013.

(51) Int. Cl. B32B 3/12; B29C 51/08

(52) U.S. Cl. CPC B32B 3/12; B29C 51/082; B32B 2250/242; B29K 2023/065

(57) ABSTRACT

A molded plastic structure, preferably formed by compression molding, having on each side a continuous geometry of regularly arranged receptacles separated from one another by a continuous outer surface. The receptacles on opposite sides are polygonal in shape and joined at the corners thereof. The receptacles have floors on one side and top surfaces on the other side of the structures. The structures may be laminated or fused to one another, or to flat panels to create plastic structures of great strength and rigidity, suitable, for example, for building temporary road structures as well as door, wall, ceiling, and floor panels.

### CROSS-REFERENCE TO RELATED APPLICATION

This application claims the benefit of U.S. provisional patent application Ser. No. 61/916,474 filed Dec. 16, 2013.

### FIELD OF THE INVENTION

The invention is in the field of molded polymeric structures, such as but not limited to structural panels having a novel two-sided geometry that results in high structural strength and readily controllable physical characteristics. The structure exhibits two similar, but not necessarily identical side geometries, one side herein called an “obverse” while the opposite side is a “reverse”. Both sides are characterized by regularly arranged polygonal receptacles wherein the obverse receptacles are joined in part to the reverse receptacles by common walls. The receptacles can have four-sided floors and are bounded by intersecting flat top surfaces. The structures can be “skinned”; i.e., panels can be fused to the top surfaces to close the receptacles on one or both sides. Alternatively or additionally, the structures can be fused to one another in stacks with or without intervening skins. The structures can be essentially flat or contoured. The structure is preferably manufactured using a compression molding technique which enhances material distribution but can also be injection molded. Structures, molds and process steps are described.

### BACKGROUND OF THE INVENTION

Cellular and semi-cellular structures made wholly or partially of polymeric material are well-known. For example, a corrugated sheet may be laminated between two flat sheets to produce a panel having relatively high compression and bending strengths. Honeycomb structures are also known to have high structural strength-to-weight ratios.

Thermoforming is a well-known technique for creating three-dimensional articles from extruded flat plastic sheets. A problem associated with thermoforming is the fact that it is difficult to control the distribution of material from the original flat sheet as it is drawn into the thermoforming mold by vacuum or other means in a heated flowable condition; i.e., the deeper the cavity into which the heat-softened sheet material must be drawn, the thinner the material becomes relative to the original gauge or thickness of the starting sheet. In addition, it can be difficult to control the distribution of material in a thermoforming process. Thickness can be well controlled by injection molding but large parts with complex geometries may require gas assist or other special techniques.

### BRIEF SUMMARY OF THE INVENTION

A first aspect of the invention is a molded polymeric article of two-sided cellular geometry wherein the cells or receptacles are regularly distributed in side-by-side fashion in such a way as to provide high strength and a high strength-to-weight ratio.

In one specific embodiment hereinafter described in detail, the cells or receptacles are three-dimensional and symmetrical in the sense that they look the same although offset when viewed from obverse and reverse sides; i.e., the walls and receptacles viewed from the obverse side include walls of adjacent cells when viewed from the reverse side. Receptacle floors on the obverse side are coplanar corner surfaces on the reverse side and vice versa. In one described embodiment, each cellular shape is characterized by four downwardly and inwardly sloping full depth walls ending in a four-sided floor, and four partial depth triangular walls forming vertically oriented ribs. These vertical ribs lie between the upper portions of the adjacent inwardly sloping walls to form receptacles that are effectively eight-sided in plan view. As hereinafter described in detail, articles made in accordance with this disclosure may vary in size and proportion. While essentially flat structures are described, they may also be curved or contoured.

In another embodiment, also hereinafter described, the obverse and reverse sides are dissimilar, the ribs are thicker, and the intersections of the ribs are purely cruciform in shape; i.e., they do not form four-sided figures as in the previous embodiment.

In still other embodiments, the ribs may be attenuated in size or may be eliminated altogether. In short, there are many possible variations in the design and configuration of the subject panel for the manufacturer or end user to choose from; likewise, there are many applications for the structure from building construction to temporary road surfaces to pallet decks.

In accordance with another aspect of the invention, the articles described above are preferably manufactured by way of a compression molding process involving two similar, conjugal male-type molds with projecting mold elements that are installed in a press so they may be brought into location between one another as the press closes; i.e., the projecting elements of one mold interfit with and between projecting elements of the opposite mold and define a continuous clearance that is ultimately filled with plastic to form the invention article. Skinning or stacking is carried out in a secondary operation.

In the preferred embodiment hereinafter described, the vertical walls or “ribs” are triangular and the apex of an upper triangular rib on the obverse side meets the apex of an inverted and lower triangular wall on the reverse side turned at 90° from the upper wall. This produces beam strength.

In accordance with a third aspect of the invention, the article as described above is made by way of a compression molding process in which a flat sheet of heat-softened material such as high-density polyethylene (HDPE) is placed between parallel conjugal molds having the character as essentially described above. The molds are brought together under pressure, usually hydraulic, to deform the sheet material in opposite directions away from the base plane, thereby bi-directionally forming the cells or receptacles on both sides of the resulting structural component or article. The compression molding process is preferred because it can produce a desired material distribution that cannot normally be realized by other techniques.

In accordance with a fourth aspect of the invention, structural panels, building walls and floors, temporary roadways, pallet decks and legs, and a wide variety of other articles can be fabricated by laminating additional plastic structural components such as flat panels to the article made as described as above. In one example, flat sheets or “skins” can be placed over the flat surfaces on either side of the article to close the receptacles. Skinning can be done on one or both sides. In another example, flat or curved sheets can be laminated to both sides of the symmetrically molded cellular article to close the cells on both sides and additional layers of cellular material may be built up in a parallel fashion to create an overall structure of the desired thickness and strength. In still another iteration on the basic theme, two symmetrically cellular panels can be fused together face-to-face with the symmetric and regularly arranged open cells of one panel in registry with the open cells of another panel so that the two panels together form a regular distribution of closed cells.

The following specification illustrates the invention and describes the various aspects and embodiments thereof with reference to drawings of molded and/or moldable articles as well as drawings of a mold which is used in a complemental, conjugal or mating fashion to form the illustrated articles out of flat sheets of heat-softened HDPE or other polymeric material. These sheets may come directly from an extruder in which case, they are preheated to the desired temperature or they may be premanufactured and stored, in which case, they are reheated and softened before entering into the press for the formation of the final article.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF SUMMARY OF THE DRAWINGS

The description herein makes reference to the accompanying computer drawings and photographs showing different embodiments and molds.

FIG. 1 is a perspective drawing of a section of a first illustrative molded article embodying the invention;

FIG. 2 is a perspective view of half of a mold set for making the article of FIG. 1;

FIG. 3 is a plan view of a mold;

FIG. 4 is a sectional view of two complementary molds brought together to form and compress a layer of HDPE between them;

FIG. 5 is a phantom view through a molded article showing how mutually inverted triangular cell ribs meet to provide beam strength;

FIG. 6 is a perspective view partly in section of another molded article of taller geometry relative to the article of FIG. 1;

FIG. 7 shows a laminated or “skinned” structural panel; and

FIG. 8 is a perspective view of the article of FIG. 1 laminated to a flat bottom panel; and

FIG. 9 is a plan view of an alternative embodiment of the invention with a different geometry.

### DETAILED DESCRIPTION

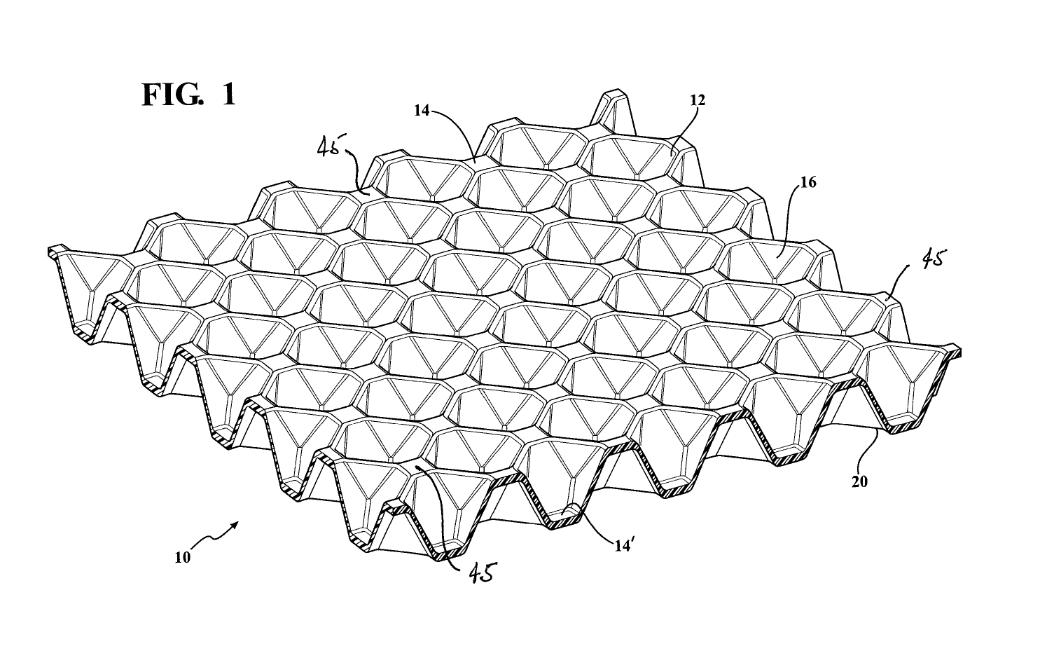

FIG. 1 shows a representative portion of a molded HDPE article 10 from the obverse side, with the understanding that, in this embodiment, the reverse side may or may not be identical and offset by one geometric “period” in all directions. The article 10 exhibits a regular geometry of open full-depth receptacles, each of which has four full depth, six-sided, tapered walls 12 interspersed with four substantially vertical, three-sided walls 16 forming ribs between adjacent receptacles. The result is an eight-sided geometrical figure when viewed in plan from the top or obverse side. The tops of the ribs intersect to form square coplanar lands 45 on the top plane. Ribs on the reverse side intersect to form similar lands that are the floors 14′ and on the obverse.

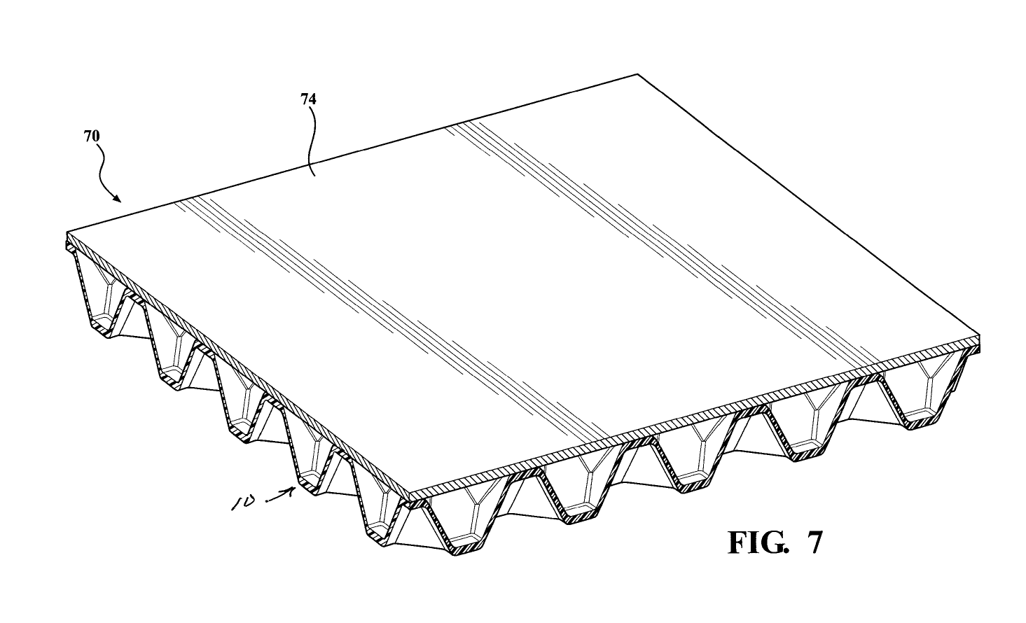

The tapered walls 12, each with six sides, and full depth, have sides intersecting with the rib walls 16 and other lower sides that intersect with the sloping walls of adjoining walls in the same receptacle. The top and bottom edges of walls 12 form the co-planar square areas 14 and 14′. These co-planar surfaces can receive and be fused or otherwise adhered to a flat panel 74 as shown in FIG. 7 to form a “skinned” article 70 having what may be used as a load-bearing deck. This article also can serve as a structural panel for building a floor, ceiling, roof, temporary roadway, pallet, or any of a host of other objects.

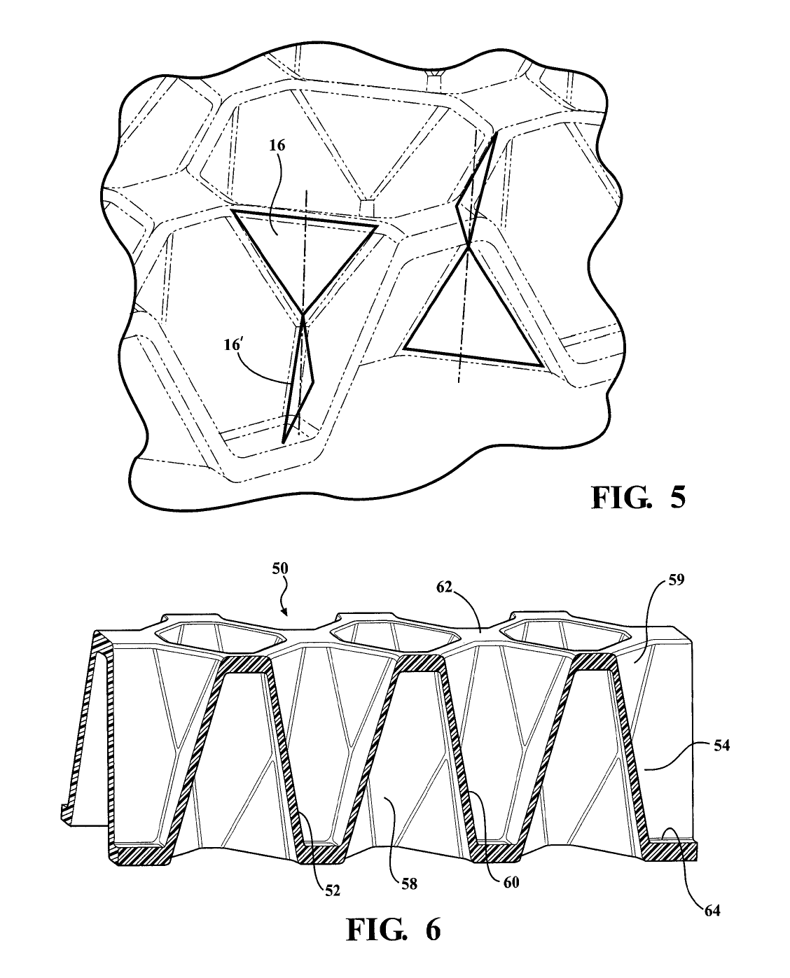

The triangular rib-forming vertical walls 16 in a given cell on the obverse are common walls with adjoining receptacles. In addition, the apex of a rib wall 16 meets the apex of an inverted rib wall 16′ on the reverse side, the plane of the latter 16′ being rotated 90° relative to the plane of the wall as shown in FIG. 5 to provide beam strength. The floors 14′ can be thicker than the walls 16; the ribs can be thicker or thinner, and may also be attenuated or eliminated altogether.

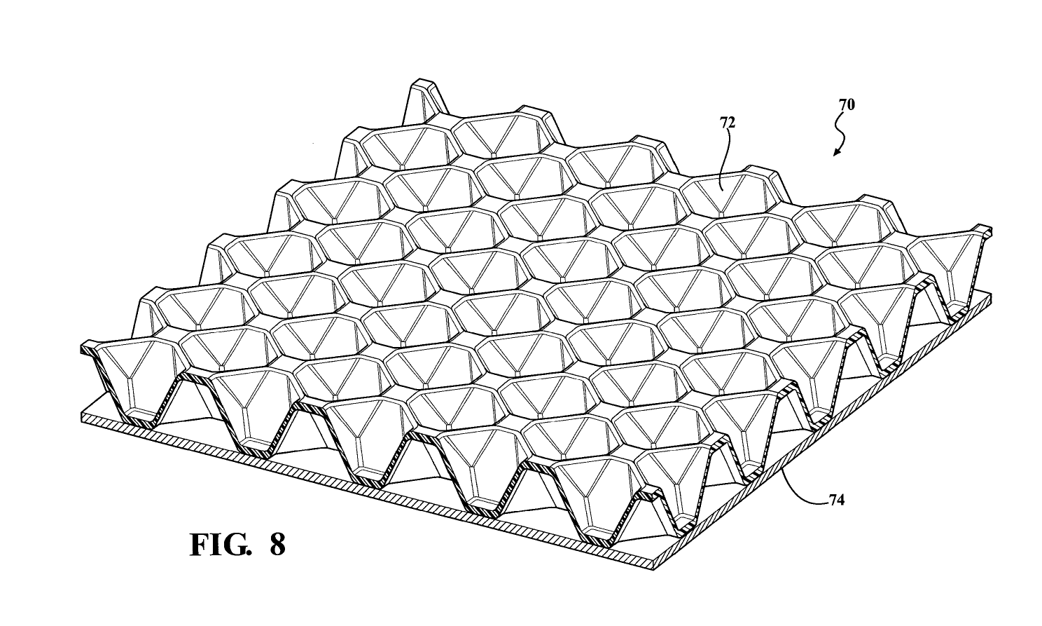

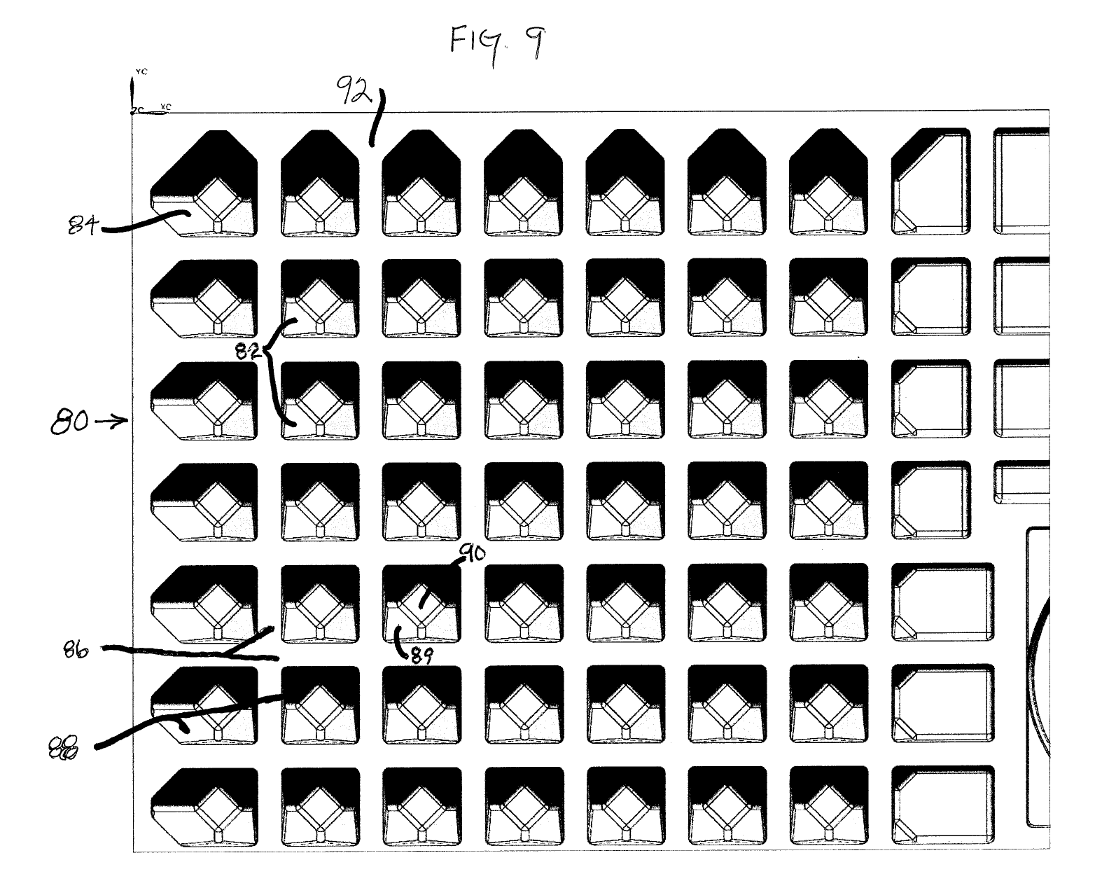

In the embodiment or FIGS. 1, 5, 7, and 8, the thickness of the material in the top and bottom plane surfaces 14 and 14′ can be greater than the thickness of the walls 12 similar to the manner in which the top and bottom plates of an I-beam are generally made thicker than the center rib of the I-beam. This contrasts with what would result if article 10 were thermoformed; i.e., these walls would be normally thinner than the original unformed sheet. In addition, the areas of the planar surfaces 14 and 14′ provide large areas for fusing additional structures to the articles 10. For example, identical articles 10 may be fused to one another in face-to-face relationship to create closed cell structures in which the cells are double the height of the open cells shown in FIGS. 1 and 6. Alternatively, flat sheets of plastic may be laminated over the articles 10 to close the cells, as shown in FIGS. 7 and 8. It should be understood that while the drawings show the laminated structure in which a flat sheet has been laminated over one side, additional sheets may be laminated to the opposite surface of article 10 to close both sides of the symmetrical cell arrangement.

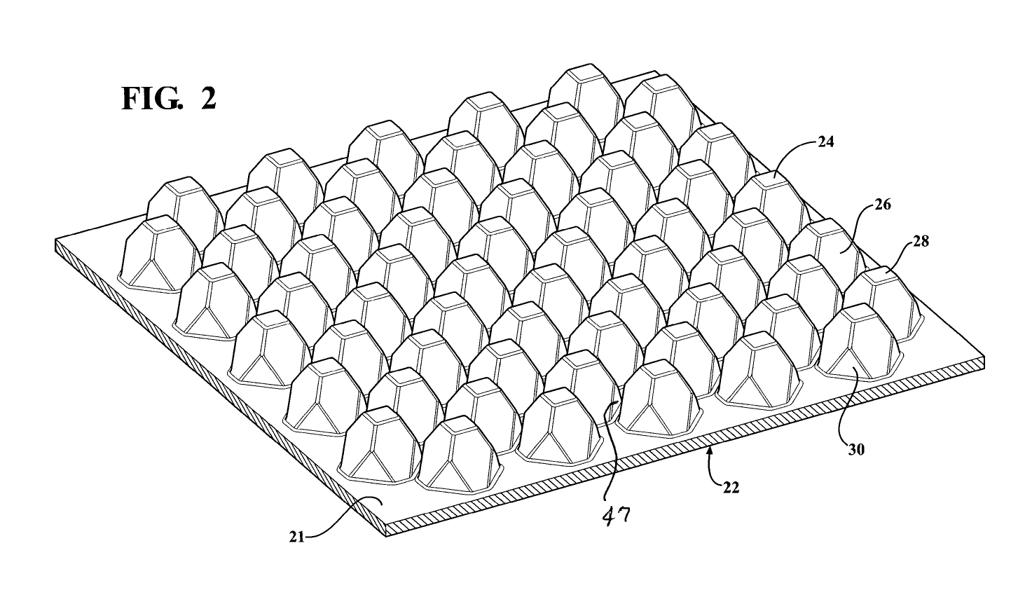

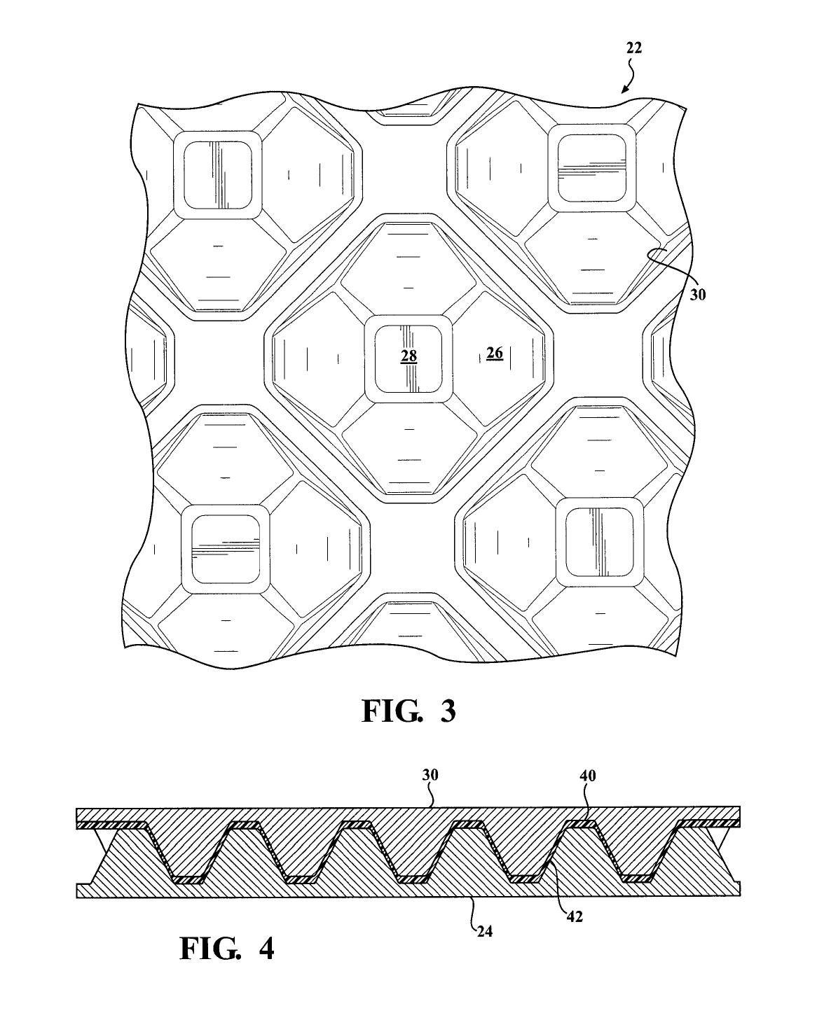

FIGS. 2, 3, and 4 illustrate part or all of a mold apparatus which can be used to make the invention article. FIG. 2 shows one such mold 22 to have a platen 21 with upwardly projecting elements 24 arranged in a regular two-dimensional pattern. Each mold element comprises a set of four six-sided surfaces 26, a top planar surface 28 which is parallel to the plane of the plate 22 and a set of four triangular surfaces 30 which are integral with the angled surfaces 26 but which are substantially orthogonal to the plane of the base plate 22 of the mold. The elements 24 are spaced apart to provide a continuous clearance that, as persons skilled in the molding art will realize, defines the molded article geometry when two conjugal platens or molds are brought together as shown in FIG. 4. It will be further noted that there are slot-like vertical clearances 47 between closely adjacent surface projections or elements 24 that form the clearances 47. Each projection has four such surfaces arranged at 90° intervals around the base of the projection. The upper mold does not extend into the clearances 47 and, therefore, plays no part in forming the rib walls 16 on the side of the structure shown. The other mold (not shown) has surfaces that form the inverted ribs as explained with reference to FIG. 5.

It will be appreciated that the apparatus shown in FIGS. 2, 3, and 4 is suitable for use in a compression molding process wherein the two platens 24, 30 are driven together by hydraulic pressure in a conventional mold press. This is the preferred method of molding the article 10. However, it is to be understood that the articles 10 may also be fabricated using conventional injection molding techniques wherein at least one of the mold plates 24, 30 is provided with openings or sprues for the inflow of fluid plastic from the injection molding machinery. It is also to be understood that while HDPE is described as the preferred material for molding the articles 10 and associated articles also described herein, articles 10 also may be made of polypropylene or other alloyed or reinforced polymers depending on the desired strength and other characteristics for the finished article.

FIG. 6 shows an article 50 similar in geometry to article 10 but taller. The tapered, full height walls are shown at 52, 58, and 60 while the vertical partial walls are at 59. The obverse top surfaces are at 62 while the floors are at 64. Again, the floors are thicker than the walls. The slope angles of walls 52 are more vertical than walls 12 because of the greater height.

While the article 50 shown in FIG. 6 is taller than the article 10 shown in FIG. 1, it will be appreciated that the geometry; i.e., the arrangement of sloping and vertical walls is similar as between the two articles 10 and 50, and that both articles exhibit interconnected vertical ribs with square or diamond-shaped intermediate surfaces, both top and bottom, creating areas to receive, where desired, skin sheets or other structural components, such as inverted articles of identical construction.

FIG. 8 shows an article 70 comprising the laminated or fused combination of a compression molded cellular HDPE article 72 and a flat sheet 74 of HDPE material. The two elements 72, 74 have been joined by thermal fusing to create a laminated structure which can be used for a variety of purposes including structural panels, temporary roads or runways, floors and a wide variety of other structures. Sheet 74 is fused to the surfaces of article 70 corresponding to the square top surfaces 12 or the bottom surfaces 14 of article 10. The wide geometry of the cells in the article 70 shown in these figures is exactly the same as that of the articles 10 and 50 shown in the previous figures, the primary difference being the fact that a flat sheet 74 has been laminated over and fused to one side of the cellular structure effectively closing the cells that would otherwise be open from that side of the structure. There are many uses of such resulting articles wherein one side of the cellular structure is left open and the other side is closed. Alternatively, another flat sheet can be fused to the opposite side of the article 70 in which case all of the cells are closed. Still another alternative is to fuse or otherwise attach a mirror image cellular article to the article 72 so as to create double-high closed cells wherein the flat surfaces which are parallel to the original base plane are brought together and fused together by thermal welding.

FIG. 9 is a plan view of another article 80 showing 7 rows and 7 column of receptacles or cells 82. The topmost row and the left most column have cells 84 that are different in geometry from the cells 82 as hereinafter described.

Cells 84 are essentially four-sided in top plan view, are separated by ribs 86 that form purely cruciform intersections; i.e., there are no square lands at the intersections of the ribs 86. This is the result of making the vertical rib-forming walls 88 thicker than the corresponding rib walls in the embodiment of FIG. 1. However, each cell 82 also has sloping walls 89 with bottom boundaries that form the four-sided floors 90 of the cells a shown. The cells 84 are enlarged on the outside and virtually eliminate one of the rib-forming vertical walls. The lattice-like surface 92 lies entirely in a single plane.

The process by which the articles described herein are made may involve (1) the manufacture of a set of molds having the geometries disclosed herein and proportions according to the desired proportions and dimensions of the final article. This is preferably done by model-making and CNC Machining. The two molds are made in such a way as to provide the necessary clearances between elements such as 24 to perform the vertical ribs as described above and to exhibit the necessary structural strength and heat resistance to allow them to carry out the compression molding process.

The molds are then arranged facing one another in a hydraulic press of sufficient size and strength as to allow the molds to travel toward one another and apart from one another to cycle through the molding process. Sheets of material, such as HDPE of the desired thickness or gage are brought into position between the two opposing complemental molds. The sheets are either preheated or brought directly from an extrusion press in heat-softened condition so as to be ready for the compression molding process. The mold plates are then brought together to the desired degree under the desired pressure to squeeze, compress and cause material from the sheet to flow into the geometry between the mold elements until all of the clearance between the two mold plates has been completely filled. The mold plates are held in this condition until the article has been fully formed and are then withdrawn from one another and the resulting article is removed from the press. A cooling step may be performed at the appropriate time in this sequence. This is conventional and need not be described in detail.

Thus, the disclosure has a number of different aspects: the first aspect is the molded article and its specific and advantageous cellular geometry. The second aspect is the structural article which can be constructed using lamination techniques wherein two or more molded articles are brought together or individual molded articles as described above are laminated to flat sheets on one or both sides of the structural panel or other article of manufacture. The third aspect is the compression molding technique which involves the creation or construction of molds having the desired complemental geometries and the use of those molds in combination with sheets of heated plastic material to form articles of the desired shape, size and proportions as described herein.

The principal characteristic of the molded article, whether created in accordance with or by use of the compression molding process described above or by injection molding, is a geometry characterized by a two-dimensional, two-sided array of receptacles or “cells” having sloping side walls and precise wall thicknesses and material distribution so as to maximize strength while at the same time eliminating wasteful allocation of material into thick vertical sections where thin structures work equally well or better. The receptacles on the obverse and reverse sides may be identical or different in geometry. The cells may have ribs or no ribs and floors or open holes. Where ribs are present, they may be thick or thin or of intermediate thickness; they may intersect in a pure cruciform area or in a four-sided land. Finally, both open cell articles and skinned, closed cell articles are possible in accordance with the teachings herein.

What is claimed is:

1. A molded plastic structure having as a continuous geometry a two-sided array of side-by-side receptacles, each receptacle on at least one side comprises:
four full depth quadrilaterally arranged, multi-sided and inwardly sloping walls;
each of the full depth walls being six-sided and tapered inwardly from top to bottom and joined side-to-side near the bottoms.

2. The molded plastic structure defined in claim 1 wherein the receptacles open to a common interconnecting top surface, the article further comprising a panel fused to the top surface to close at least some of the receptacles.

3. The molded plastic structure defined in claim 1 wherein the majority of the receptacles are of constant size and periodicity.

4. A molded structure as defined in claim 1 wherein the material of construction is high-density polyethylene.

5. The molded structure defined in claim 1 wherein each receptacle has, interspersed with said full depth, tapered walls, four substantially vertical walls, at least some of which are common to an adjoining receptacle to form a substantially vertical rib, the ribs of adjacent receptacles intersecting to form a substantially continuous top surface.

6. The structure defined in claim 5 wherein the ribs intersect so as to form a four-sided figure that is part of said continuous top surface.

7. The structure defined in claim 1 wherein the receptacles have floors that are thicker than the side walls of each receptacle.

8. The structure of claim 6 wherein the walls forming the ribs are triangular, the apex of a first upper triangular wall integrally meeting the apex of an inverted lower triangular wall, the plane of which is rotated 90° from the plane of the upper triangular wall.

9. A method of manufacturing a molded plastic structure having the configuration defined in claim 1 comprising the steps of:
arranging two, complementally contoured mold platens in registry to one another and with projections defining the shape of said receptacles extending toward one another but being interleaved with the projections of one another so as to form said walls when brought together;
placing a layer of moldable polymeric material between said molds; and
closing said molds on said layer to deform said layer by compression into the continuous space between the projections of said molds to form the geometry of said structure.

10. An apparatus for manufacturing a compression molded structure having the geometry defined in claim 1 and comprising:
a first mold having a regularly arranged geometry of projections to form half of the receptacles and geometry defined in claim 1;
a second mold having a regular geometry of projections extending therefrom and interfitting with the projections of the first mold, but configured and sized to form a continuous space between said molds to provide continuous room for filling with plastic material to form a continuous structure; and
means for urging the molds together to compress a volume of moldable polymeric material into said continuous space.

11. A compression molded structure made according to the method defined in claim 9 wherein the sloping walls meet a floor and wherein the material thickness of the floors is greater than the material thickness of the walls.
